(19) United States
(12) Patent Application Publication
(10) Pub. No.: US 2018/0284960 A1
(43) Pub. Date: Oct. 4, 2018

(54) APPARATUS, SYSTEM, AND METHOD FOR ESTABLISHING A PUSH-TO-TALK COMMUNICATION

(71) Applicant: MOTOROLA SOLUTIONS, INC., Chicago, IL (US)

(72) Inventors: Valentina Dmitrievna Borisova, Saint-Petersburg (RU); Fedor Grigorievich Saveliev, Saint-Petersburg (RU)

(21) Appl. No.: 15/766,343

(22) PCT Filed: Oct. 26, 2015
(86) PCT No.: PCT/RU2015/000708

§ 371 Date: Apr. 5, 2018

(51) Int. Cl. G06F 3/0482

(52) U.S. Cl. CPC G06F 3/0482; G06F 3/0488

(57) ABSTRACT

Apparatus, system, and method for establishing a push-to-talk communication. One method includes generating, with the electronic processor, a graphical user interface including a cylindrically-scrollable list containing a plurality of contacts and a selection indicator and displaying, with the electronic processor, the graphical user interface on the touch screen. The method also includes receiving, with the electronic processor, a first user input and a second user input through the touch screen. The first user input aligns the selection indicator with one of the plurality of contacts contained in the cylindrically-scrollable list, and the second user input selects the selection indicator. The method also includes, in response to receiving the second user input, transmitting, with the communication device, an audio communication to at least one communication device associated with the one of the plurality of contacts over a communication channel.

### BACKGROUND OF THE INVENTION

Some communication devices, such as mobile telephones and two-way radios, provide push-to-talk functionality. Push-to-talk is a method of transmitting audio communications over a half-duplex communication channel. Push-to-talk is a common way of performing public safety communications (e.g., communications between police officers, first responders, and the like).

Prior to starting a push-to-talk communication, a user selects a contact, which may be an individual or a group of individuals. After selecting a contact, the user then places the communication device into a transmit mode that transmits an audio communication received through a microphone of the communication device to the selected contact. After transmitting the audio communication, the user places the communication device into a reception mode to receive a response to the audio communication.

Some communication devices include a mechanical input mechanism to place the communication device into the transmit mode and the reception mode. For example, a communication device may include a momentary switch that places the communication device into the transmit mode when the momentary switch is pressed and places the communication device into the reception mode when the momentary switch is released. Also, some communication devices include a mechanical input mechanism, such as a rotatable knob, for selecting a contact for a push-to-talk communication.

As an alternative to or in addition to the mechanical input mechanisms, a communication device may execute a push-to-talk software application that generates and displays a graphical user interface on a touchscreen of the communication device. The graphical user interface includes a selection mechanism for receiving a contact selection and a separate selection mechanism for receiving a communication mode selection (e.g., reception mode or a transmit mode). The graphical user interface may eliminate the need for mechanical input mechanisms and may also be configurable for a particular communication device or a particular user of the communication device.

However, the separate selection mechanisms provided through a graphical user interface may increase the amount of user interaction required to establish a push-to-talk communication. Furthermore, depending on the number of contacts available for selection or the size of the touch screen, the graphical user interface may only be able to display a portion of the available contacts at one time. Accordingly, a user may need to access separate screens or separate portions of a screen to select a contact and place the communication device into the transmit mode to establish a push-to-talk communication, which introduces delay and potential errors. Accordingly, there is a need for systems and methods that provide an efficient process for conducting a push-to-talk communication.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication device.

FIG. 2 is a flowchart illustrating a method of establishing a push-to-talk communication using the communication device of FIG. 1.

FIGS. 3 and 4 are graphical user interfaces illustrating a list and a selection indicator.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments of the invention provide systems, methods, and non-transitory computer-readable medium containing instructions for establishing a push-to-talk communication. One embodiment provides a method of operating a communication device having an electronic processor and a touch screen. The method includes generating, with the electronic processor, a graphical user interface including a cylindrically-scrollable list containing a plurality of contacts and a selection indicator and displaying, with the electronic processor, the graphical user interface on the touch screen. The method also includes receiving, with the electronic processor, a first user input through the touch screen, wherein the first user input aligns the selection indicator with one of the plurality of contacts contained in the cylindrically-scrollable list. The method also includes receiving, with the electronic processor, a second user input through the touch screen, wherein the second user input selects the selection indicator. In addition, the method includes, in response to receiving the second user input, transmitting, with the communication device, an audio communication to at least one communication device associated with the one of the plurality of contacts over a communication channel.

Another embodiment provides a communication device comprising a touch screen, a transceiver, and an electronic processor. The electronic processor is configured to generate a graphical user interface including a cylindrically-scrollable list containing a plurality of contacts and a selection indicator and display the graphical user interface on the touch screen. The electronic processor is also configured to receive a first user input through the touch screen, wherein the first user input aligns the selection indicator with one of the plurality of contacts contained in the cylindrically-scrollable list. The electronic processor is also configured to receive a second user input through the touch screen, wherein the second user input selects the selection indicator. In addition, the electronic processor is configured to, in response to receiving the second user input, transmit an audio communication to at least one communication device associated with the one of the plurality of contacts over a communication channel through the transceiver.

Yet another embodiment provides a non-transitory computer-readable medium containing instructions that, when executed by an electronic processor, perform a set of functions. The set of functions comprising generating a graphical user interface including a cylindrically-scrollable list containing a plurality of contacts and a selection indicator associated with the cylindrically-scrollable list and displaying the graphical user interface on a touch screen. The set of functions also comprising receiving a first user input through the touch screen, wherein the first user input aligns the selection indicator with one of the plurality of contacts contained in the cylindrically-scrollable list and receiving a second user input through the touch screen, wherein the second user input selects the selection indicator. The set of functions further comprises, in response to receiving the second user input, transmitting an audio communication to at least one communication device associated with the one of the plurality of contacts over a communication channel.

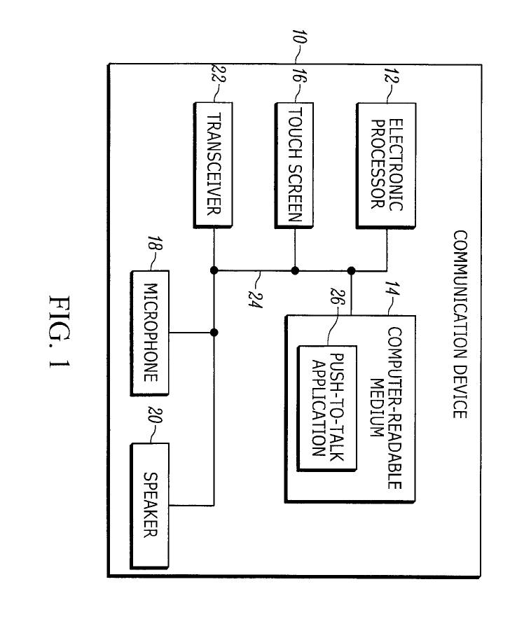

FIG. 1 is a block diagram of a communication device 10. The communication device 10 may be, for example, a personal computer (e.g., a desktop computer, laptop computer, or tablet computer), a mobile telephone, a watch with communication capabilities, a television, a pager, a two-way radio, or a combination thereof. In some embodiments, the communication device 10 is a two-way radio used by public safety personnel, such as first responders and police officers. Also, in some embodiments, the communication device 10 is a converged device used by public safety personnel to communicate over multiple communication networks, including, for example, a cellular network and a radio network (e.g., a land mobile radio (LMR) network).

The communication device 10 includes an electronic processor 12, non-transitory computer-readable medium 14, a touch screen 16, a microphone 18, a speaker 20, and a transceiver 22. The electronic processor 12, the computer-readable medium 14, the touch screen 16, the microphone 18, the speaker 20, and the transceiver 22 communicate through one or more communication lines or buses 24. It should be understood that in other constructions, the communication device 10 includes additional, fewer, or different components than those illustrated in FIG. 1.

The computer-readable medium 14 (e.g., read-only memory, random-access memory, or combinations thereof) stores instructions and data. The electronic processor 12 retrieves instructions from the computer-readable medium 14 and executes the instructions to perform a set of functions including the methods described herein. For example, as illustrated in FIG. 1, the computer-readable medium 14 stores a push-to-talk (PTT) application 26.

The touch screen 16 is a touch-sensitive interface that displays output (e.g., webpages and other graphical user interfaces (GUIs) generated by software applications executed by the electronic processor 12) and also receives user input using detected physical contact (e.g., detected capacitance or resistance). In some embodiments, the touch screen 16 includes a liquid crystal display (LCD).

The transceiver 22 establishes push-to-talk communications. In some embodiments, the transceiver 22 transmits and receives audio data over a half-duplex communication channel (e.g., over a two-way radio network, and the like). In other embodiments, the transceiver 22 transmits and receives audio data over a full-duplex communication channel. For example, in some embodiments, the transceiver 22 transmits and receives half-duplex communications (e.g., push-to-talk communications) over a full-duplex communication channel (e.g., using push-to-talk over cellular, push-to-talk over broadband, or simulated half-duplex over full-duplex). When transmitting a push-to-talk communication, the transceiver 22 initially receives audio data through the microphone 18 and transmits the received audio data over a data communication network. Similarly, when receiving a push-to-talk communication, the transceiver 22 outputs the received audio data through the speaker 20.

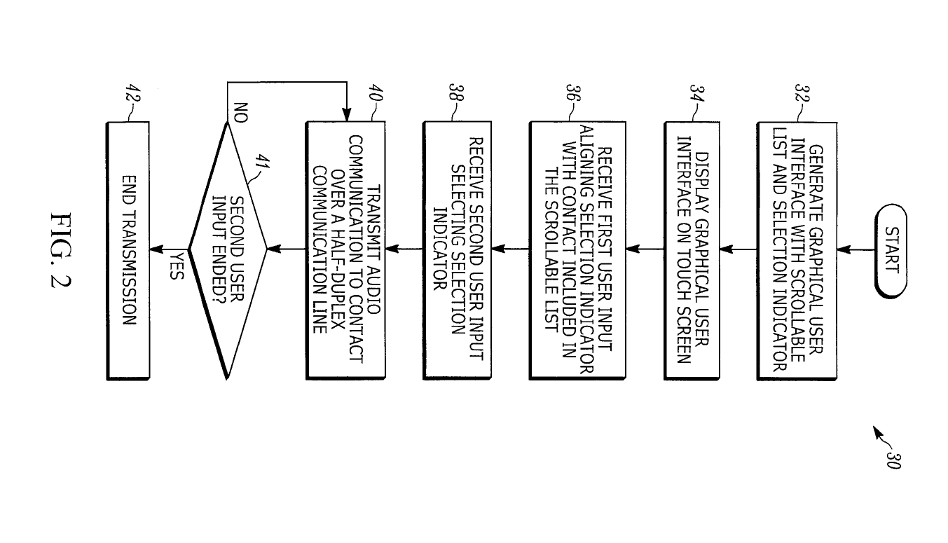

As noted above, the computer-readable medium 14 stores a push-to-talk application 26. The push-to-talk application 26 is executed by the electronic processor 12. FIG. 2 is a flow chart illustrating a method 30 performed by the push-to-talk application 26 (as executed by the electronic processor 12) to establish a push-to-talk communication. As illustrated in FIG. 2, the push-to-talk application 26 generates a graphical user interface that includes a list and a selection indicator (at block 32) and displays the graphical user interface through the touch screen 16 (at block 34).

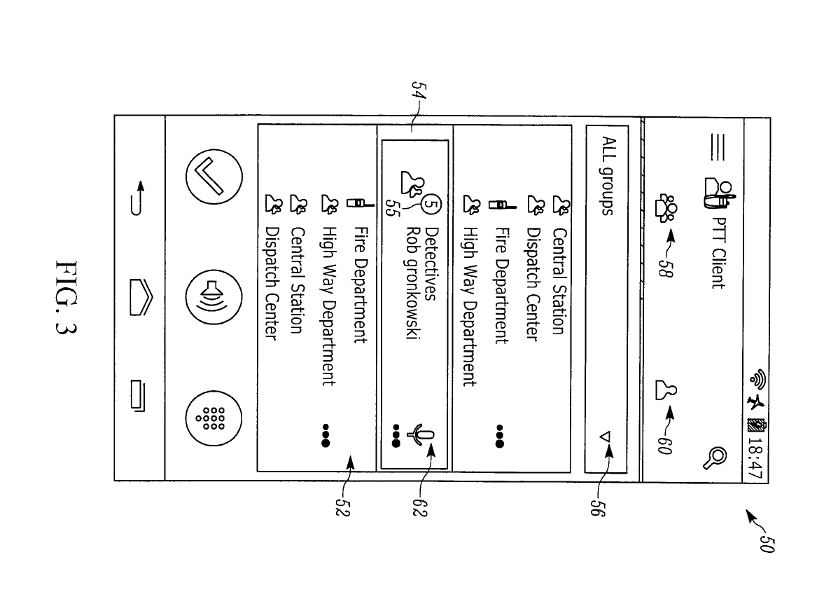

FIG. 3 illustrates one example of a graphical user interface 50 that includes a list 52 and a selection indicator 54. The list 52 includes a plurality of contacts. Each contact is associated with a data record (e.g., stored on the communication device 10 or an external device accessible by the communication device) that stores contact information (e.g., one or more telephone numbers) for a single entity (e.g., an individual or a location, such as a dispatch center) or a plurality of entities (e.g., a group of individuals, such as a group of public safety personnel). Each data record is associated with a name identifying the entity or group of entities (e.g., “Detectives”). As illustrated in FIG. 3, in some embodiments, the list 52 displayed within the graphical user interface 50 only includes the contact names and does not display the associated contact information. However, as illustrated in FIG. 3, each contact name included in the list 52 may be displayed with an icon representing a particular category for the contact name (e.g., whether the contact name represents a single entity, a group of entities, a particular location, and the like). Also, in some embodiments, when a contact is associated with a group of entities, the list 52 can display how many entities are included in the group. For example, as illustrated in FIG. 3, a contact displayed with the list 52 may have a number icon 55 that indicates how many entities are associated with a contact (e.g., the “Detectives” contact includes five entities).

It should be understood that, in some embodiments, the data records associated with the plurality of contacts included are manually configurable (e.g., through the communication device 10) to add, delete, and modify data records (e.g., set or modify a contact name or associated contact information).

In some embodiments, the list 52 is filterable. For example, as illustrated in FIG. 3, the graphical user interface 50 may include a drop-down menu 56. The drop-down menu 56 includes a list of contact categories. The categories may include “all contacts,” “public safety contacts,” “personal contacts,” “emergency contacts,” “work contacts,” and the like. When user input is received through the touch screen 16 selecting a particular category included in the drop-down menu 56, the push-to-talk application 26 automatically updates the list 52 based on the selected category.

Alternatively or in addition, the graphical user interface 50 may include one or more filter selection mechanisms. Each filter selection mechanism is associated with a predefined contact category. Accordingly, as compared to the drop-down menu 56, a filter selection mechanism may more efficiently receive user input selecting a particular category of contacts. For example, as illustrated in FIG. 3, the graphical user interface 50 may include a group filter selection mechanism 58 and an individual filter selection mechanism 60. In response to receiving user input selecting the group filter selection mechanism 58, the push-to-talk application 26 automatically updates the list 52 to include only those contacts associated with groups of entities. Similarly, in response to receiving user input selecting the individual filter selection mechanism 60, the push-to-talk application 26 automatically updates the list 52 to include only those contacts associated with individual entities.

In one embodiment, as illustrated in FIG. 3, the list 52 is movable. In particular, in some situations, only a portion of the list 52 is viewable at one time within the graphical user interface 50 (e.g., less than ten contacts may be viewable). However, in response to user input received through the touch screen 16 (e.g., a swipe or a selection of a selection mechanism), the list 52 is moved (i.e., scrolled) to display other portions of the list 52 (e.g., contacts positioned before the currently displayed contacts or contacts positioned after the currently displayed contacts within the list 52). The list 52 may be movable in one or more directions (e.g., scrollable upward and downward).

Also, in some embodiments, as illustrated in FIG. 3, the list 52 is displayed as a cylindrically-scrollable list. Within a cylindrically-scrollable list, the contacts are displayed as if they were positioned on a surface of a cylinder. Accordingly, in this configuration, the list may be scrolled indefinitely in one direction without reaching an end of the list. For example, when a flat-scrollable list is scrolled down to an end of the list, the list must be scrolled up to reach the start of the list. Alternatively, when a cylindrically-scrollable is scrolled down to an end of the list, the list may be further scrolled down to reach the start of the list again. In some embodiments, the cylindrically-scrollable list includes a non-static number of contacts.

The selection indicator 54 is alignable with one of the contacts included in the list 52 to select one of the contacts included in the list 52. For example, as illustrated in FIG. 3, in some embodiments, the selection indicator 54 is a graphical border (e.g., a frame) that is superimposed on at least a portion of the list 52. The graphical border is sized such that at least a portion of one of the plurality of contacts included in the list 52 is viewable within the border. Accordingly, the selection indicator 54 is alignable with one of the contacts included in the list 52 by positioning one of the contacts included in the list 52 within the graphical border.

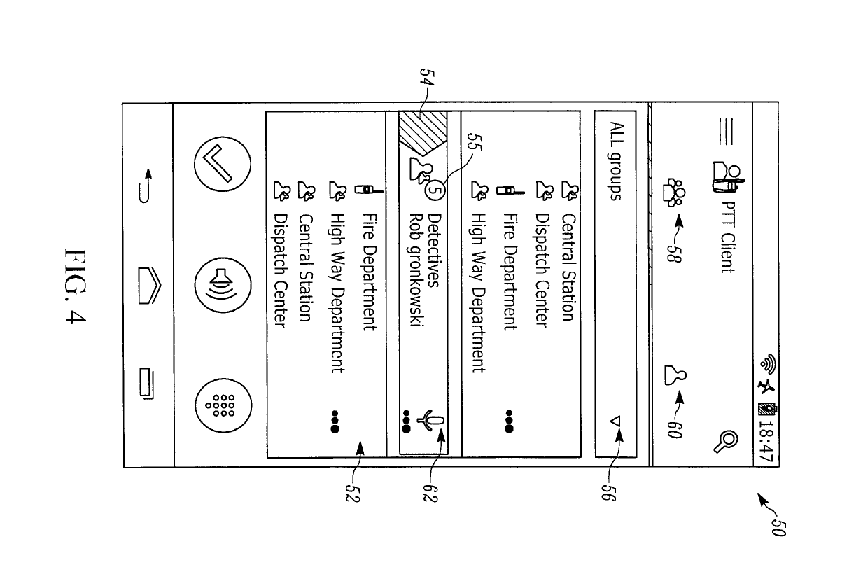

In other embodiments, the selection indicator 54 includes a symbol displayed adjacent to the list 52. For example, as illustrated in FIG. 4, in some embodiments, the selection indicator 54 is an arrow that points to one of the contacts included in the list. Accordingly, in this configuration, the selection indicator 54 is alignable with one of the contacts included in the list 52 by positioning one of the contacts included in the list 52 adjacent to the arrow. It should also be understood that the selection indicator 54 may take other forms than those illustrated in FIGS. 3 and 4, which are provided merely as examples.

The selection indicator 54 is aligned with one of the plurality of contacts included in the 52 by moving the selection indicator 54, the list 52, or a combination thereof. For example, in some embodiments, the selection indicator 54 is displayed at a static position within the graphical user interface 50 and the list 52 moves (e.g., scrolls) relative to the selection indicator 54. Alternatively, the selection indicator 54 may be movable with respect to the list 52 (e.g., by selecting and dragging the selection indicator 54 to a particular position within the graphical user interface 50).

In some embodiments, the contact aligned with the selection indicator 54 (e.g., viewable within the graphical border or positioned adjacent to the symbol) is modified (e.g., magnified, bolded, italicized, colored, flashed, and the like) to contrast the contact (i.e., the selected contact) from the other contacts included in the list 52 (i.e., the non-selected contacts).

Returning to FIG. 2, after displaying the graphical user interface 50, the push-to-talk application 26 receives a first user input through the touch screen 16, wherein the first user input aligns the selection indicator 54 with one of the plurality of contacts contained in the list 52 (at block 36). As noted above, the selection indicator 54 may be movable with respect to the list 52 or the list 52 may be movable with respect to the selection indicator. Accordingly, the selection indicator 54 is aligned with one of the plurality of contacts included in the list 52 through user input moving (i.e., scrolling) the list 52, the selection indicator 54, or a combination thereof.

After receiving the first user input, the push-to-talk application 26 receives a second user input through the touch screen 16, wherein the second user input is a selection the selection indicator 54 (at block 38). For example, the second user input may include a touch of the selection indicator 54 for a predetermined period of time or a press of the selection indicator 54 with a predetermined amount of pressure. Similarly, in some embodiments, the second user input may include a swipe of the selection indicator 54, a two-finger touch of the selection indicator 54, or another form of user input. In response to receiving the second user input, the push-to-talk application 26 transmits (through the transceiver 22) an audio communication to a communication device associated with the one of the plurality of contacts aligned with the selection indicator 54 (i.e., the selected contact) over a communication channel (at block 40). Accordingly, selection of the selection indicator 54 places the communication device 10 into a transmit mode where audio data received through the microphone 18 is transmitted by the transceiver 22 over a communication channel. Thus, selection of the selection indicator 54 initializes a push-to-talk communication or call.

The communication device associated with the selected contact (i.e., the device receiving the audio communication) may include similar components as the communication device 10 described above. Alternatively, the communication device associated with the selected connect may be any device capable of push-to-talk communication. Also, a communication device may be associated with a selected contact by being assigned a telephone number associated with the selected contact. Also, it should be understood that if the selected contact is associated with multiple entities, the push-to-talk application 26 transmits the audio communication to a communication device associated with each entity associated with the selected contact (e.g., each telephone number associated with the contact).

As illustrated in FIG. 2, in some embodiments, the push-to-talk application 26 transmits an audio communication to the selected contact as long as the second user input is received (i.e., as long as the selection indicator 54 is touched or pressed). When the second user input ends (at block 41), the push-to-talk application 26 ends the transmission of the audio communication (at block 42). In particular, when the selection indicator 54 is not selected, the communication device 10 is placed in a reception mode where the communication device 10 may receive audio data through the transceiver 22 over a communication channel, which is output through the speaker 20. In some embodiments, the push-to-talk application 26 indicates the current mode (e.g., transmit mode or reception mode) of the communication device 10 through the graphical user interface 50. For example, the push-to-talk application 26 may modify the selection indicator 54 depending on whether the communication device 10 is in the transmit mode or the reception mode (e.g., by changing the color, size, animation, and the like of the selection indicator 54). Alternatively or in addition, the push-to-talk application 26 may display an icon, such as speaker icon 62 (see FIGS. 3 and 4), that appears or is modified based on the current mode of the communication device 10.

Thus, embodiments of the invention provide systems and methods for improving graphical user interfaces used to initiate a push-to-talk communication by providing a selection indicator that both selects a contact for the communication and initiates transmission of the communication. Providing a single selection indicator for these functions reduces the number of screens or areas of a graphical user interface requiring user interaction. Also, because the selection indicator used to initiate the communication also indicates the currently-selected contact, a push-to-talk communication is less likely established with the wrong contact. These considerations allow a push-to-talk application to provide a more convenient and efficient user interface for initiating a push-to-talk communication.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of operating a communication device having an electronic processor and a touch screen, the method comprising:
generating, with the electronic processor, a graphical user interface including a cylindrically-scrollable list containing a plurality of contacts and a selection indicator;
displaying, with the electronic processor, the graphical user interface on the touch screen;
receiving, with the electronic processor, a first user input through the touch screen, the first user input aligning the selection indicator with one of the plurality of contacts contained in the cylindrically-scrollable list;
receiving, with the electronic processor, a second user input through the touch screen, the second user input selecting the selection indicator; and
in response to receiving the second user input, transmitting, with the communication device, an audio communication to at least one communication device associated with the one of the plurality of contacts over a communication channel.

2. The method of claim 1, wherein generating the graphical user interface includes generating the selection indicator as a graphical border super-imposed on at least a portion of the cylindrically-scrollable list.

3. The method of claim 2, wherein receiving the first user input includes receiving user input moving the cylindrically-scrollable list to align the one of the plurality of contacts within the graphical border.

4. The method of claim 2, wherein receiving the first user input includes receiving user input moving the graphical border to position the graphical border over the one of the plurality of contacts.

5. The method of claim 1, wherein generating the graphical user interface includes generating the selection indicator as a symbol positioned adjacent to the cylindrically-scrollable list.

6. The method of claim 5, wherein receiving the first user input includes receiving user input moving the cylindrically-scrollable list to position the one of the plurality of contacts adjacent to the symbol.

7. The method of claim 5, wherein receiving the first user input includes receiving user input moving the symbol to position the symbol adjacent to the one of the plurality of contacts.

8. The method of claim 1, wherein receiving the second user input includes receiving a touch of the selection indicator for a predetermined period of time.

9. The method of claim 1, further comprising ending transmission of the audio communication in response to an end of the second user input.

10. The method of claim 1, wherein transmitting the audio communication includes transmitting a push-to-talk communication.

11. A communication device comprising:
a touch screen;
a transceiver; and
an electronic processor configured to
generate a graphical user interface including a cylindrically-scrollable list containing a plurality of contacts and a selection indicator,
display the graphical user interface on the touch screen,
receive a first user input through the touch screen, the first user input aligning the selection indicator with one of the plurality of contacts contained in the cylindrically-scrollable list,
receive a second user input through the touch screen, the second user input selecting the selection indicator, and
in response to receiving the second user input, transmit an audio communication to at least one communication device associated with the one of the plurality of contacts over a communication channel through the transceiver.

12. The communication device of claim 11, wherein the selection indicator is displayed at a static position within the graphical user interface and wherein the cylindrically-scrollable list is movable relative to the selection indicator.

13. The communication device of claim 11, wherein the electronic processor is configured to receive the first user input by receiving user input moving the cylindrically-scrollable list to align the one of the plurality of contacts with the selection indicator.

14. The communication device of claim 11, wherein the electronic processor is configured to receive the first user input by receiving user input moving the selection indicator to align the selection indicator with the one of the plurality of contacts.

15. The communication device of claim 11, wherein the electronic processor is configured to receive the second user input by receiving user input touching the selection indicator for a predetermined period of time.

16. The communication device of claim 11, further comprising a microphone and wherein the electronic processor receives the audio communication through the microphone.

17. The communication device of claim 11, wherein the electronic processor is further configured to access a data record associated with the one of the plurality of contacts, wherein the data record includes contact information for a plurality of entities.

18. The communication device of claim 11, wherein the electronic processor is further configured to end transmission of the audio communication in response to an end of the second user input.

19. The communication device of claim 11, wherein the audio communication includes a push-to-talk communication.

20. A non-transitory computer-readable medium containing instructions that, when executed by an electronic processor, perform a set of functions comprising:
generating a graphical user interface including a cylindrically-scrollable list containing a plurality of contacts and a selection indicator associated with the cylindrically-scrollable list;
displaying the graphical user interface on a touch screen;
receiving a first user input through the touch screen, the first user input aligning the selection indicator with one of the plurality of contacts contained in the cylindrically-scrollable list;
receiving a second user input through the touch screen, the second user input selecting the selection indicator; and
in response to receiving the second user input, transmitting an audio communication to at least one communication device associated with the one of the plurality of contacts over a communication channel.

21. The non-transitory computer-readable medium of claim 20, wherein the instructions for receiving the first user input through the touch screen includes instructions for receiving user input moving the cylindrically-scrollable list to align the one of the plurality of contacts with the selection indicator.

22. The non-transitory computer-readable medium of claim 20, wherein the instructions for receiving the second user input through the touch screen includes instructions for receiving user input touching the selection indicator for a predetermined period of time.

23. The non-transitory computer-readable medium of claim 20, wherein the instructions for transmitting the audio communication includes instructions for transmitting a push-to-talk communication.
